(19) United States
(12) Patent Application Publication
(10) Pub. No.: US 2024/0283058 A1
(43) Pub. Date: Aug. 22, 2024

(54) FUEL CELL SYSTEM

(71) Applicant: Honda Motor Co., Ltd., Tokyo (JP)

(72) Inventors: Seiji Takaya, Tokyo (JP); Masanori Matsushita, Tokyo (JP); Morio Kayano, Tokyo (JP); Kenichi Shimizu, Tokyo (JP); Kenta Suzuki, Tokyo (JP); Suguru Yamanaka, Tokyo (JP); Satoshi Oshima, Tokyo (JP); Takaharu Watanabe, Tokyo (JP)

(21) Appl. No.: 18/439,995

(22) Filed: Feb. 13, 2024

(30) Foreign Application Priority Data
Feb. 21, 2023 (JP) 2023-024894

(51) Int. Cl. H01M 16/00; H01M 8/04537; H01M 8/04746

(52) U.S. Cl. CPC H01M 16/006; H01M 8/04559; H01M 8/04753; H01M 2250/20

(57) ABSTRACT

A fuel cell system includes a microprocessor configured to perform, during an external power supply in which power is supplied to an external load, controlling a power generation of a fuel cell so as to generate a power at a predetermined power generation efficiency and supplying a surplus power not consumed out of the generated power of the fuel cell to a battery to charge the battery. The controlling includes, during the external power supply, stopping the power generation of the fuel cell when a charge rate of the battery becomes a first predetermined value or larger, controlling an output of the battery so that the power of the battery is supplied to the external load, and resuming the power generation of the fuel cell when the charge rate becomes a second predetermined value smaller than the first predetermined value or lower.

### CROSS-REFERENCE TO RELATED APPLICATION

This application is based upon and claims the benefit of priority from Japanese Patent Application No. 2023-024894 filed on Feb. 21, 2023, the content of which is incorporated herein by reference.

### BACKGROUND OF THE INVENTION

### Field of the Invention

The present invention relates to a fuel cell system mounted on a vehicle driven by a motor.

### Description of the Related Art

A device configured to supply power of a fuel cell and a power storage device mounted on a fuel cell vehicle to an external load such as a device outside the vehicle is known (for example, refer to JP 2014-56771 A).

Since power generation efficiency of the fuel cell reaches its maximum in a predetermined power generation amount range, when required power from the external load is equal to or smaller than the power generation amount range, efficient power generation control becomes difficult. In contrast, if it is tried to generate power equal to or larger than the required power by giving priority to the power generation efficiency, when the required power drastically decreases, a surplus of the generated power excessively flows into the power storage device side, and the power storage device might be deteriorated.

### SUMMARY OF THE INVENTION

An aspect of the present invention is a fuel cell system has an external power supply function of supplying power of a battery and power of a fuel cell to an external load. The fuel cell system includes a microprocessor and a memory coupled to the microprocessor. The microprocessor is configured to perform, during an external power supply in which power is supplied to an external load, controlling a power generation of the fuel cell so as to generate a power at a predetermined power generation efficiency and supplying a surplus power not consumed out of the generated power of the fuel cell to the battery to charge the battery. The microprocessor is configured to perform the controlling including, during the external power supply, stopping the power generation of the fuel cell when a charge rate of the battery becomes a first predetermined value or larger, controlling an output of the battery so that the power of the battery is supplied to the external load, and resuming the power generation of the fuel cell when the charge rate becomes a second predetermined value smaller than the first predetermined value or lower.

### BRIEF DESCRIPTION OF THE DRAWINGS

The objects, features, and advantages of the present invention will become clearer from the following description of embodiments in relation to the attached drawings, in which:

FIG. 1 is a schematic configuration diagram illustrating an example of a vehicle system including a fuel cell system according to an embodiment of the invention;

FIG. 2 is a diagram illustrating a connection relationship between an external power supply system and its peripheral devices;

FIG. 3 is a diagram illustrating an example of a correspondence relationship between a power generation efficiency and a generated power of a fuel cell;

FIG. 4 is a diagram for explaining a method of determining a power generation target value;

FIG. 5 is a flowchart illustrating an example of processing executed by the power control unit in FIG. 1;

FIG. 6A is a diagram for explaining an operation of the power control unit in FIG. 1; and

FIG. 6B is a diagram for explaining an operation of the power control unit in FIG. 1.

### DETAILED DESCRIPTION OF THE INVENTION

### <Overview>

In a fuel cell vehicle equipped with a vehicle system including a fuel cell system according to an embodiment of the invention, a motor for travel is driven using at least one of power (FC power) generated by a fuel cell (hereinafter, sometimes referred to as FC) and power (battery power) stored in a secondary battery of the vehicle system. Power (regenerative power) generated during regeneration from the motor for travel is stored in the secondary battery of the vehicle system. Furthermore, the vehicle system has an external power supply function of supplying at least one of the FC power and the battery power to an electric device (hereinafter, referred to as an external load) connected to a power supply port provided on the fuel cell vehicle. Such vehicle system will be hereinafter described in detail with reference to the drawings.

### <Fuel Cell Vehicle>

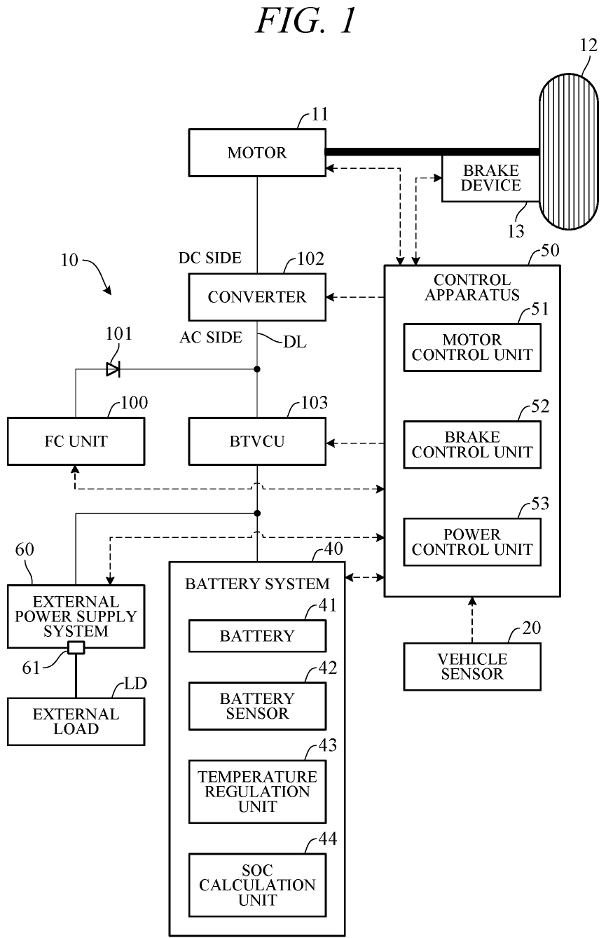

FIG. 1 is a schematic configuration diagram illustrating an example of a vehicle system including a fuel cell system 10 according to the present embodiment. The vehicle system is mounted on a fuel cell vehicle as an example of an electric vehicle driven by a motor 11. The vehicle system is provided with at least the motor 11 for travel, a driving wheel 12, a brake device 13, a vehicle sensor 20, a battery system (power storage device) 40, a control device 50, an external power supply system 60, an FC unit 100, a converter 102, and a battery voltage control unit (BTVCU) 103. A diode 101 is disposed between the FC unit 100 and the converter 102 and BTVCU 103 in order to prevent backflow. The fuel cell system 10 forms a part of the vehicle system, and includes the battery system 40, the control device 50, the external power supply system 60, the FC unit 100, and the BTVCU 103. In the drawing, solid lines connecting blocks indicate electrical connection, and broken lines connecting the control device 50 and the blocks exemplify directions of signals.

### <Motor>

The motor 11 is, for example, a three-phase AC electric motor. A rotor of the motor 11 is coupled to the driving wheel 12. The motor 11 outputs a driving force to the driving wheel 12 by using at least one of the FC power generated by the FC unit 100 and the battery power stored in the battery system 40 (power operation). The motor 11 generates power using kinetic energy of the fuel cell vehicle when the fuel cell vehicle decelerates (regenerative operation).

### <Brake Device>

The brake device 13 is provided with, as an example, a brake caliper, a cylinder that transmits a hydraulic pressure to the brake caliper, and an electric motor that generates the hydraulic pressure in the cylinder (none is illustrated). The brake device 13 may be provided with, as a backup, a mechanism that transmits the hydraulic pressure generated by an operation of a brake pedal to the cylinder via a master cylinder. The brake device 13 is not limited to the above-described configuration, and may be an electronically controlled hydraulic brake device that transmits the hydraulic pressure of the master cylinder to the cylinder.

### <Vehicle Sensor>

As an example, the vehicle sensor 20 is provided with an accelerator opening degree sensor, a vehicle speed sensor, and a brake stepping amount sensor (none is illustrated). The accelerator opening degree sensor is attached to an accelerator pedal as an example of an operator that receives an acceleration instruction from a driver, detects an operation amount of the accelerator pedal, and outputs the same to the control device 50 as an accelerator opening degree. The vehicle speed sensor is provided with, for example, a wheel speed sensor attached to each wheel and a speed calculator (none is illustrated), integrates wheel speeds detected by the respective wheel speed sensors to derive a speed of the fuel cell vehicle (vehicle speed), and outputs the same to the control device 50. The brake stepping amount sensor is attached to a brake pedal, detects an operation amount of the brake pedal, and outputs the same to the control device 50 as a brake stepping amount.

### <Converter>

The converter 102 is, for example, a bidirectional DC voltage/AC voltage converter. A DC side terminal of the converter 102 is connected to a DC link DL. The battery system 40 is connected to the DC link DL via the BTVCU 103. The converter 102 converts the DC voltage boosted by the BTVCU 103 into a three-phase AC voltage and supplies the same to the motor 11. The converter 102 converts an AC voltage generated by the regenerative operation of the motor 11 into a DC voltage and outputs the same to the DC link DL. The voltage obtained by the regenerative operation may be referred to as a regenerative voltage.

### <BTVCU>

The BTVCU 103 includes, for example, a boosting/stepping-down type DC voltage converter. The BTVCU 103 outputs a DC voltage obtained by boosting a DC voltage supplied from the battery system 40 to the DC link DL. The BTVCU 103 steps down the regenerative voltage by the motor 11 or a DC voltage output from the FC unit 100 and outputs the same to the battery system 40. The voltage output from the FC unit 100 may be referred to as an FC voltage.

### <Battery System>

As an example, the battery system 40 is provided with a battery 41, a battery sensor 42, a temperature regulation unit 43, and an SOC calculation unit 44.

The battery 41 is, for example, a secondary battery such as a lithium-ion battery. As an example, the battery 41 stores (charges) regenerative power obtained by the regenerative operation of the motor 11 or the FC power obtained by a power generating operation of the FC unit 100, and discharges for allowing the fuel cell vehicle to travel and operating an auxiliary equipment to be described later.

As an example, the battery sensor 42 is provided with a current sensor, a voltage sensor, a temperature sensor and the like (none is illustrated). The current sensor, the voltage sensor, and the temperature sensor detect a current value, a voltage value, and temperature of the battery 41, respectively. The battery sensor 42 outputs signals indicating the detected current value, voltage value, and temperature and the like to the control device 50.

The temperature regulation unit 43 heats or cools the battery 41 using power supplied from the battery 41 via the BTVCU 103, for example. As an example, the temperature regulation unit 43 is controlled by a battery electronic control unit (ECU) not illustrated so that the temperature of the battery 41 detected by the battery sensor 42 falls within a predetermined temperature range.

The SOC calculation unit 44 calculates a state of charge (SOC) of the battery 41 on the basis of the output of the battery sensor 42. The SOC calculation unit 44 outputs a signal indicating the calculated SOC to the control device 50.

### <FC Unit>

The FC unit 100 includes a fuel cell. The fuel cell generates power by hydrogen contained as fuel in fuel gas and oxygen contained as an oxidant in air reacting with each other. In the embodiment, the FC power generated by the FC unit 100 is output to the above-described DC link DL. As a result, the FC power from the FC unit 100 is supplied to the motor 11 via the converter 102 or supplied to the battery system 40 via the BTVCU 103. The FC power supplied to the battery system 40 is stored in the battery 41.

### <External Power Supply System>

The external power supply system 60 is provided with a power supply port 61 for electrically connecting an external load LD to the fuel cell system 10. The FC power from the FC unit 100 and the battery power from the battery system 40 are input to the external power supply system 60. The external power supply system 60 has an external power supply function of supplying at least one of the FC power and the battery power to the external load LD connected to the power supply port 61. When a connector (not illustrated) of the external load LD is connected to the power supply port 61, the external power supply system 60 outputs an external power supply request signal to be described later to the control device 50 (power control unit 53). The external power supply system 60 establishes communication with the external load LD connected to the power supply port 61 via the connector, and acquires device information (model information, rated power consumption (maximum power consumption) and the like) of the external load LD via the communication. The external power supply system 60 stores the device information in a storage unit (not illustrated) of the control device 50. The external power supply system 60 may have an external charging function of converting the AC voltage supplied from the external power source (not illustrated) to DC voltage and supplying the same to the battery system 40 to charge the battery 41. In this case, the power supply port 61 also functions as a charge port for electrically connecting the external power source to the fuel cell system 10.

### <Control Device>

The control device 50 includes a CPU (microprocessor) and a storage unit such as a ROM and a RAM, and includes an input/output interface such as a timer circuit, an A/D converter, and a D/A converter as necessary. The control device 50 is not limited to include only one control unit, and may include a plurality of control units included in the motor 11, the FC unit 100, the battery system 40, the external power supply system 60, the BTVCU 103 and the like.

The control device 50 determines while alleviating distribution (sharing) of a load that the FC unit 100 should bear, a load that the battery system 40 should bear, and a load that the motor 11 as a regenerative power source should bear from a load required of the vehicle system as an entire fuel cell vehicle determined on the basis of inputs (load requests) from various switches, various sensors and the like not illustrated in addition to the state of the FC unit 100, the state of the battery 41, the state of the external power supply system 60, and the state of the motor 11, and transmits a command to the motor 11, the converter 102, the FC unit 100, the battery system 40, and the BTVCU 103. As an example, the above-described control device 50 is provided with a motor control unit 51, a brake control unit 52, and a power control unit 53. As described above, the motor control unit 51, the brake control unit 52, and the power control unit 53 may be replaced with separate control units (for example, a motor ECU, a brake ECU, a battery ECU and the like), respectively.

As an example, the motor control unit 51 calculates a driving force required of the motor 11 on the basis of an output of the vehicle sensor 20, and controls the motor 11 so as to output the calculated driving force.

As an example, the brake control unit 52 calculates a braking force required of the brake device 13 on the basis of the output of the vehicle sensor 20, and controls the brake device 13 so as to output the calculated braking force.

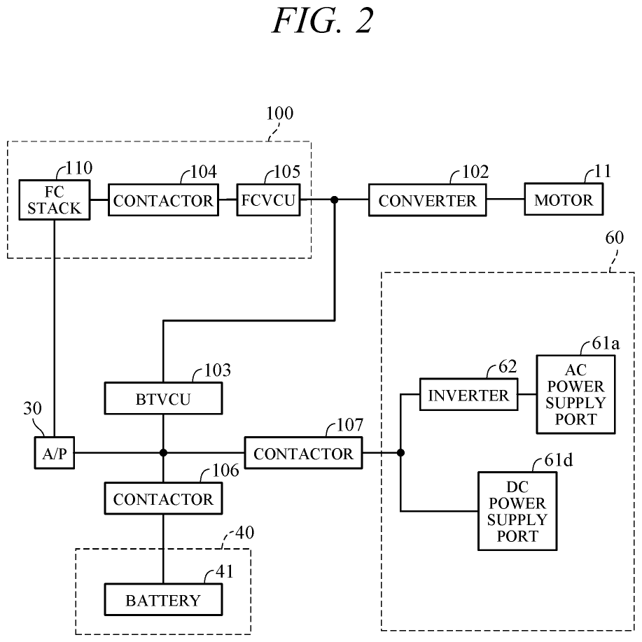

As an example, the power control unit 53 calculates total required power required of the battery system 40 and the FC unit 100 on the basis of the output of the vehicle sensor 20. For example, the power control unit 53 calculates torque that the motor 11 should output on the basis of the accelerator opening degree and vehicle speed, and calculates a drive shaft required power obtained from the torque and a rotational speed of the motor 11. The power control unit 53 calculates the total required power by summing up the drive shaft required power, the power required by the auxiliary equipment and the like, and the external power supply required power. The auxiliary equipment is driven using at least one of the battery power and the FC power. The auxiliary equipment includes, for example, an air pump (A/P) 30 and the like to be described later with reference to FIG. 2.

The power control unit 53 calculates charge/discharge required power of the battery 41 on the basis of the SOC of the battery 41. The power control unit 53 subtracts the charge/discharge required power of the battery 41 from the above-described total required power (a discharge side is set positive), calculates the FC required power required of the FC unit 100, and allows the FC unit 100 to generate power corresponding to the calculated FC required power.

FIG. 2 is a diagram illustrating a connection relationship between the external power supply system 60 and its peripheral devices. The external power supply system 60 is provided with the power supply port 61 (an AC power supply port 61a and a DC power supply port 61d) and an inverter 62. Contactors 104, 106, and 107 in FIG. 2 electrically connect and disconnect the external power supply system 60 to and from an FC stack 110 and the battery 41 under the control of the control device 50. A fuel cell voltage control unit (FCVCU) 105 includes, for example, a boosting type DC voltage converter. Under the control of the control device 50, the FCVCU 105 boosts a voltage on a primary side (input side) input from the FC stack 110 via the contactor 104 to a voltage corresponding to a power generation target value to be described later, and applies the same to a secondary side (output side). The air pump 30 is one of the auxiliary equipment, is provided with a motor and the like driven and controlled by the FC unit 100, and supplies the FC stack 110 with air, which is an oxidant gas (reactant gas) containing oxygen as an oxidant.

When the connector of the external load LD is inserted into either the AC power supply port 61a or the DC power supply port 61d, the external load LD and the external power supply system 60 are electrically connected to each other. When the contactor 107 is turned on (connected state), the FC power from the FC unit 100 and the battery power from the battery system 40 can be supplied to the external load LD connected to the AC power supply port 61a or the DC power supply port 61d. The AC power supply port 61a and the DC power supply port 61d detect connection or disconnection of the connector of the external load LD and output detection signals to the control device 50. The inverter 62 is provided between the contactor 107 and the AC power supply port 61a, and converts the FC power and the battery power input via the contactor 107 from direct current to alternating current.

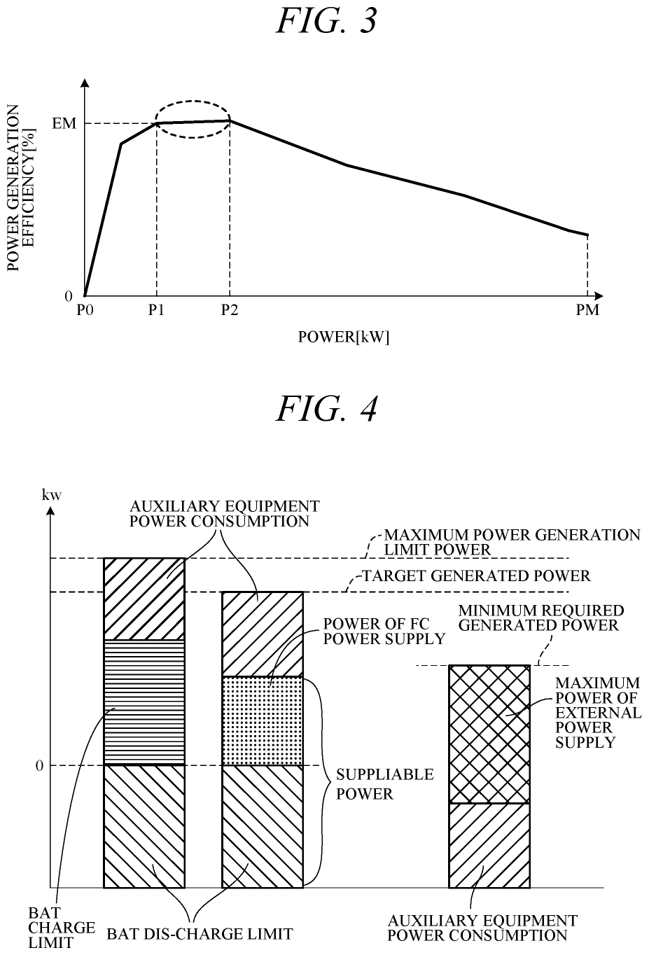

During external power supply, it is necessary to perform efficient power generation control so that power can be supplied to the external load LD connected to a power supplier for as long a time as possible. FIG. 3 is a diagram illustrating an example of a correspondence relationship between the power generation efficiency and the generated power of the FC unit 100 (FC stack 110). As illustrated in FIG. 3, the FC stack reaches its maximum power generation efficiency (hereinafter, simply referred to as maximum efficiency) EM in a range from generated power P1 to generated power P2. Hereinafter, this range is referred to as a maximum efficiency power generation range. Therefore, during the external power supply, it is preferable to generate power so that generated power P of the FC stack falls within the maximum efficiency power generation range.

In contrast, there is a case where a user suddenly stops the operation of the external load LD during the external power supply, and the electrical connection between the external power supply system 60 and the external load LD is suddenly interrupted. Hereinafter, such sudden interruption of the electrical connection between the external power supply system 60 and the external load LD is referred to as load release. In a case where the load release occurs, the power originally supposed to be supplied to the external load LD loses its destination and flows into the battery system 40. Surplus power (hereinafter, referred to as unexpected surplus power) that loses its destination at the time of load release in this manner might deteriorate or break the battery 41 of the battery system 40 depending on magnitude thereof. Therefore, during the external power supply, it is necessary to perform the power generation control of the FC unit 100 within the maximum efficiency power generation range and within a range in which the fuel cell system 10 can absorb (consume) the unexpected surplus power at the time of the load release. In consideration of this point, the power control unit 53 is configured as follows in the present embodiment. Since the external power supply function is normally used when the fuel cell vehicle stops (does not travel), the regenerative power is not input to the external power supply system 60 during the external power supply.

The power control unit 53 controls power generation of the fuel cell so as to generate power with predetermined power generation efficiency (the maximum efficiency power generation range described above) during the external power supply. The power control unit 53 supplies the surplus power, which is not consumed in the fuel cell system 10, out of the generated power of the FC stack 110 to the battery 41 to charge the battery 41.

When the SOC of the battery 41 becomes equal to or higher than a charge limit value during the external power supply, the power control unit 53 outputs a power generation stop command for stopping the power generation of the FC stack 110 to the FC unit 100. As a result, the power supply by the battery power is started. That is, the battery 41 starts discharging.

Thereafter, when the SOC of the battery 41 becomes equal to or lower than a discharge limit value (<charge limit value), the power control unit 53 outputs a power generation start command for starting the power generation of the FC stack 110 to the FC unit 100. As a result, the power generation of the FC stack 110 is resumed.

The charge limit value is a threshold for determining whether the battery 41 is fully charged. A fully charged state is, for example, a state in which the SOC is 100%. From the viewpoint of preventing deterioration of the battery 41, the charge limit value is actually set to a value smaller than 100% (for example, 80%) so as not to fully charge the battery 41. The discharge limit value is a threshold for determining whether the external power supply with only the battery 41 is disabled. From the viewpoint of preventing deterioration of the battery 41, the discharge limit value is set to a value larger than 0% so as not to fully discharge the battery 41.

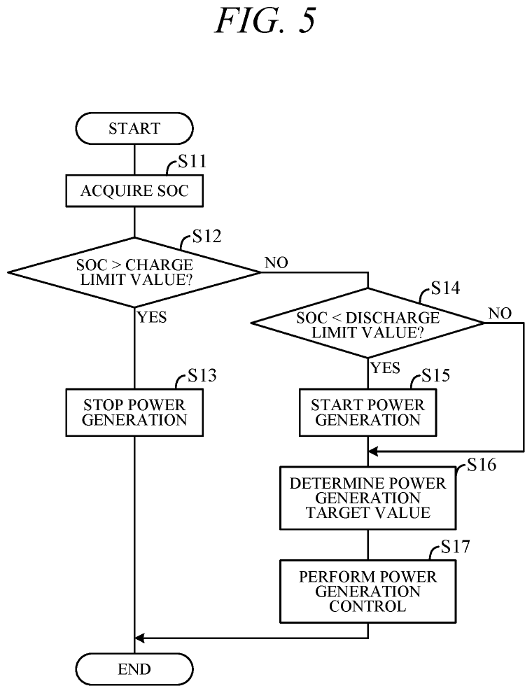

The power control unit 53 determines a power generation target value so as to be able to absorb the unexpected surplus power generated at the time of load release during the external power supply, and performs the power generation control of the FC stack 110 on the basis of the power generation target value. FIG. 4 is a diagram for explaining a method of determining the power generation target value (hereinafter, also referred to as target generated power).

### <Power Generation Upper Limit Value>

First, on the basis of the SOC of the battery 41, the power control unit 53 calculates an amount of power with which the battery 41 can be charged (hereinafter, referred to as a BAT charge limit) and an amount of power that can be discharged by the battery 41 (hereinafter, referred to as a BAT discharge limit). The power control unit 53 determines an upper limit value (hereinafter, referred to as maximum power generation limit power or a power generation upper limit value) of the generated power of the FC stack 110 on the basis of the BAT charge limit and a total value of the power consumable by the auxiliary equipment (hereinafter, referred to as auxiliary equipment power consumption). Specifically, the power control unit 53 sums up the auxiliary equipment power consumption and the BAT charge limit to calculate the power generation upper limit value. By suppressing the generated power of the FC stack 110 to the power generation upper limit value or smaller, the unexpected surplus power at the time of power supply load release can be absorbed (consumed) by the auxiliary equipment and the battery 41.

### <Power Generation Lower Limit Value>

Then, the power control unit 53 determines a lower limit value (hereinafter, referred to as minimum required generated power or power generation lower limit value) of the generated power of the FC stack 110 on the basis of the BAT discharge limit, the auxiliary equipment power consumption, and the maximum power consumption of the external load LD (hereinafter, referred to as external power supply maximum power consumption). Specifically, the power control unit 53 subtracts the BAT discharge limit from the sum of the auxiliary equipment power consumption and the external power supply maximum power consumption to calculate the power generation lower limit value. When the amount of power equal to or larger than the BAT discharge limit is discharged from the battery 41, deterioration or breakdown of the battery 41 might occur. By controlling the generated power of the FC stack 110 so as not to fall below the power generation lower limit value, it is possible to prevent the above-described deterioration or breakdown of the battery 41 due to over discharge.

### <Power Generation Target Value>

Subsequently, the power control unit 53 determines the power generation target value of the FC stack 110 on the basis of the power generation upper limit value, the power generation lower limit value, and the maximum efficiency power generation range. At that time, the power generation target value is determined in such a manner that the value falls within both a power generation limit range defined by the power generation upper limit value and the power generation lower limit value and within the maximum efficiency power generation range. For example, the power control unit 53 determines, as the power generation target value, a maximum value in a range in which the power generation limit range and the maximum efficiency power generation range overlap with each other.

When the power generation target value is determined, the power control unit 53 finally outputs a control signal indicating the power generation target value to the FC unit 100. The FC unit 100 controls the power generation of the FC stack 110 on the basis of the control signal from the power control unit 53 in such a manner that the generated power of the FC stack 110 becomes the power generation target value. Power obtained by subtracting the auxiliary equipment power consumption from the power obtained by summing up the generated power of the FC stack 110 generated on the basis of the power generation target value and the BAT discharge limit is the power that can be supplied from the fuel cell system 10 to the external load (hereinafter, referred to as suppliable power).

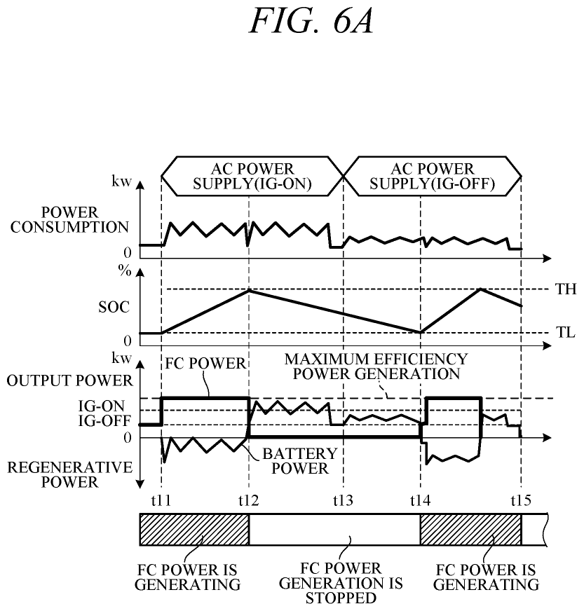

FIG. 5 is a flowchart illustrating an example of processing executed by the power control unit 53 of the control device 50. The processing in FIG. 5 is repeatedly executed at predetermined intervals when it is detected that the external load LD is connected by the AC power supply port 61a or the DC power supply port 61d of the external power supply system 60. First, at step S11, the SOC of the battery 41 is acquired. More specifically, the SOC calculated by the SOC calculation unit 44 is acquired from the battery system 40. At step S12, it is determined whether the SOC of the battery 41 is higher than a charge limit value TH. When the determination is affirmative at step S12, the power generation stop command is output to the FC unit 100 at step S13, and the power generation of the FC stack 110 is stopped. Since it takes time to resume the power generation if the power generation of the FC stack 110 is completely stopped, the power generation target value may be determined to minimum generated power of the FC stack 110 so that minimum power generation is continued by the FC unit 100, and a signal indicating the power generation target value may be output to the FC unit 100. When the determination is negative at step S12, it is determined at step S14 whether the SOC of the battery 41 is lower than the discharge limit value. When the determination is negative at step S14, the processing proceeds to step S16. When the determination is affirmative at step S14, the power generation start command is transmitted to the FC unit 100 at step S15. At step S16, the power generation target value is determined, and at step S17, the power generation control based on the power generation target value is performed. Specifically, a signal indicating the power generation target value is output to the FC unit 100.

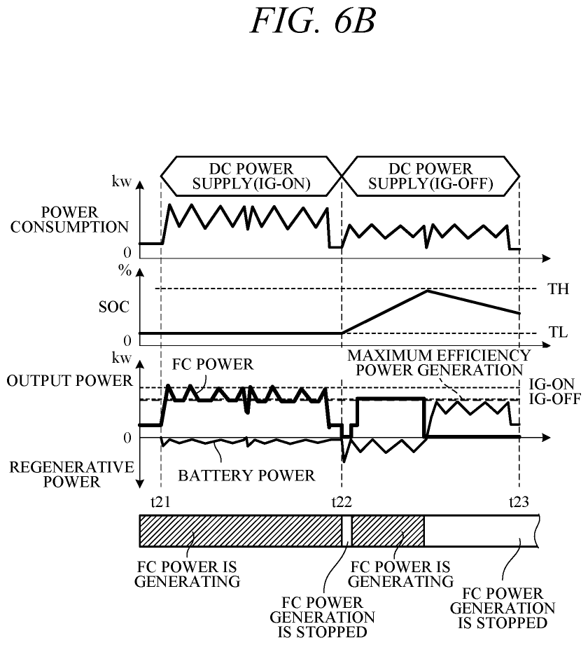

FIGS. 6A and 6B are diagrams for explaining an operation of the power control unit 53. FIG. 6A illustrates an example of the operation of the power control unit 53 during AC power supply, that is, when power is supplied to the external load LD connected to the AC power supply port 61a. When an ignition switch is turned on by a driver and the like in a state in which the ignition switch (not illustrated) of the fuel cell vehicle is turned off (accessary (ACC) power source is turned on) and the external load is connected to the AC power supply port 61a, the external power supply system 60 outputs an external power supply request signal to the control device 50 (power control unit 53). When receiving the external power supply request signal, the power control unit 53 outputs the power generation start command to the FC unit 100. Since the SOC of the battery 41 is equal to or lower than the charge limit value TH, the generated power of the FC unit 100 is supplied to the battery 41, and the battery 41 is charged (time point t11).

In the AC power supply, since the rated power consumption of the external load is small, and the sum of the external power supply maximum power consumption and the auxiliary equipment power consumption falls below the minimum power P1 of the maximum efficiency power generation range, when the power generation is performed with the maximum efficiency in the FC stack 110, the surplus power is generated as illustrated in FIG. 6A. The surplus power is supplied to the battery 41 via the BTVCU 103, and the battery 41 is charged. Thereafter, when the SOC of the battery 41 reaches the charge limit value TH, the power generation stop command is output to the FC unit 100 (time point t12). As a result, the power generation of the FC stack 110 is stopped, and power supply from the battery 41 to the external load LD and the auxiliary equipment is started. Therefore, after time point t12, the SOC of the battery 41 gradually decreases. In the example in FIG. 6A, since the ignition switch is turned off at time point t13, the output power from the battery 41 decreases after time point t13. When the SOC of the battery 41 reaches the discharge limit value TL, the power control unit 53 outputs the power generation start command to the FC unit 100 (time point t14). As a result, the power generation of the FC stack 110 is resumed. Thereafter, the power control unit 53 repeats the similar operation. Thereafter, when a stop operation of the external power supply is performed by the driver and the like, for example, when the ignition switch is turned off (ACC power source is also turned off), the external power supply system 60 outputs the external power supply stop signal to the control device 50 (power control unit 53). When receiving the external power supply stop signal, the power control unit 53 outputs the power generation stop command to the FC unit 100 (time point t15).

FIG. 6B illustrates an example of the operation of the power control unit 53 during DC power supply, that is, when power is supplied to the external load LD connected to the DC power supply port 61d. When an ignition switch is turned on by a driver and the like in a state in which the ignition switch of the fuel cell vehicle is turned off (ACC power source is turned on) and the external load LD is connected to the DC power supply port 61d, the external power supply system 60 outputs an external power supply request signal to the control device 50 (power control unit 53). When receiving the external power supply request signal, the power control unit 53 outputs the power generation start command to the FC unit 100 (time point t21).

In the DC power supply, the rated power consumption of the external load LD is large, and the sum of the external power supply maximum power consumption and the auxiliary equipment power consumption exceeds the maximum power P2 in the maximum efficiency power generation range. Therefore, when the power generation of the FC stack 110 is limited within the maximum efficiency power generation range, the power is drawn from the battery 41 in which the SOC reaches the discharge limit value TL. In order to suppress such over discharge of the battery 41, in the example illustrated in FIG. 6B, the generated power of the FC stack 110 is output beyond the maximum efficiency power generation range after time point t21. At that time, since all the generated power of the FC stack 110 is consumed by the external load LD and the auxiliary equipment, no surplus power is generated. As a result, the battery 41 is not charged. When the ignition switch is turned off at time point t22, the auxiliary equipment power consumption decreases, and the sum of the external power supply maximum power consumption and the auxiliary equipment power consumption falls below the minimum power P1 in the maximum efficiency power generation range. Therefore, after time point t22, the power generation with the maximum efficiency is performed in the FC stack 110, and a part (surplus power) of the generated power is supplied to the battery 41 via the BTVCU 103, and the battery 41 is started to be charged. Since an operation until the stop operation of the external power supply is performed by the driver and the like at time point t23 is similar to the operation of the AC power supply in FIG. 6A, the description thereof will be omitted.

According to the embodiments described above, the following actions and effects are obtained.
(1) A fuel cell system 10 has an external power supply function of supplying power of a battery 41 and power of a FC stack (fuel cell) 110 to an external load LD. A power control unit 53 as a power generation control unit to control power generation of the FC stack 110 so as to generate power at predetermined power generation efficiency (more specifically, maximum power generation efficiency) and supply surplus power not consumed out of the generated power of the FC stack 110 to the battery 41 to charge the battery during external power supply in which power is supplied to the external load LD is provided. The power control unit 53 stops the power generation of the FC stack 110 when a charge rate of the battery 41 becomes a first predetermined value (charge limit value) or larger, controls an output of the battery 41 so that the power of the battery 41 is supplied to the external load LD, and resumes the power generation of the FC stack 110 when the charge rate becomes a second predetermined value (discharge limit value) smaller than the first predetermined value or lower during the external power supply. As a result, efficient power generation control of the fuel cell can be satisfactorily implemented.
(2) The power control unit 53 determines an upper limit value (power generation upper limit value) of the generated power of the FC stack 110 on the basis of power that can be consumed by an auxiliary equipment such as an air pump 30 and a state of charge (SOC) of the battery 41. The power control unit 53 determines a lower limit value (power generation lower limit value) of the generated power of the FC stack 110 on the basis of the power that can be consumed by the auxiliary equipment and a maximum power consumption of the external load LD. Furthermore, the power control unit 53 sets a power generation target value of the FC stack 110 between the power generation upper limit value and the power generation lower limit value. As a result, it is possible to perform efficient power generation control within a range in which unexpected surplus power can be absorbed.

The above-described embodiments can be modified in various modes. Hereinafter, variations will be described. In the above-described embodiment, the air pump 30 is described as an example of the auxiliary equipment; the auxiliary equipment may include an air conditioner, an FC cooling device and the like not illustrated mounted on the fuel cell vehicle. In the above-described embodiment, the external power supply system 60 acquires the device information of the external load LD via communication, but a method of acquiring the device information is not limited thereto.

The above embodiment can be combined as desired with one or more of the above modifications. The modifications can also be combined with one another.

According to the present invention, efficient power generation control of the fuel cell can be satisfactorily implemented.

Above, while the present invention has been described with reference to the preferred embodiments thereof, it will be understood, by those skilled in the art, that various changes and modifications may be made thereto without departing from the scope of the appended claims.

What is claimed is:

1. A fuel cell system has an external power supply function of supplying power of a battery and power of a fuel cell to an external load, the fuel cell system comprising:
a microprocessor and a memory coupled to the microprocessor, wherein
the microprocessor is configured to perform,
during an external power supply in which power is supplied to an external load, controlling a power generation of the fuel cell so as to generate a power at a predetermined power generation efficiency and supplying a surplus power not consumed out of the generated power of the fuel cell to the battery to charge the battery, and
the microprocessor is configured to perform
the controlling including, during the external power supply, stopping the power generation of the fuel cell when a charge rate of the battery becomes a first predetermined value or larger, controlling an output of the battery so that the power of the battery is supplied to the external load, and resuming the power generation of the fuel cell when the charge rate becomes a second predetermined value smaller than the first predetermined value or lower.

2. The fuel cell system according to claim 1, wherein
the microprocessor is configured to perform
the controlling including determining an upper limit value of the generated power of the fuel cell based on a power capable of being consumed by an auxiliary equipment driven with at least one of the power of the battery and the power of the fuel cell, and the charge rate.

3. The fuel cell system according to claim 2, wherein
the microprocessor is configured to perform
the controlling including determining a lower limit value of the generated power of the fuel cell based on the power capable of being consumed by the auxiliary equipment and a maximum power consumption of the external load.

4. The fuel cell system according to claim 3, wherein
the microprocessor is configured to perform
the controlling including setting a target value of the power generation of the fuel cell between the upper limit value and the lower limit value.

5. The fuel cell system according to claim 1, wherein
the predetermined power generation efficiency is a max power generation efficiency of the fuel cell.

6. The fuel cell system according to claim 3, wherein
the predetermined power generation efficiency is a max power generation efficiency of the fuel cell, and
the microprocessor is configured to perform
the controlling including setting a target value of the power generation of the fuel cell so that the target value is included within both a power generation limit range defined by the upper limit value and the lower limit value and a range of the maximum efficiency power generation.

7. The fuel cell system according to claim 6, wherein
the controlling including setting the target value to a maximum value in a range in which the power generation limit range and the range of the maximum efficiency power generation overlap with each other.

8. A fuel cell system has an external power supply function of supplying power of a battery and power of a fuel cell to an external load, the fuel cell system comprising:
a microprocessor and a memory coupled to the microprocessor, wherein
the microprocessor is configured to perform,
during an external power supply in which power is supplied to an external load, controlling a power generation of the fuel cell so as to generate a power at a predetermined power generation efficiency and supplying a surplus power not consumed out of the generated power of the fuel cell to the battery to charge the battery, and
the microprocessor is configured to perform:
the controlling including, during the external power supply, determining a target value of the power generation of the fuel cell to a predetermined amount of power when a charge rate of the battery becomes a first predetermined value or larger and continuing the power generation of the fuel cell according to the target value, controlling an output of the battery so that the power of the battery is supplied to the external load, and resuming the power generation of the fuel cell with the predetermined power generation efficiency when the charge rate becomes a second predetermined value smaller than the first predetermined value or lower.

9. The fuel cell system according to claim 8, wherein
the predetermined amount of power is a minimum amount of generation power required for the fuel cell to continue the power generation of the fuel cell.
